(19) United States
(12) Patent Application Publication
(10) Pub. No.: US 2009/0271436 A1
(43) Pub. Date: Oct. 29, 2009

(54) Techniques for Providing a Virtual-World Object Based on a Real-World Object Description

(76) Inventor: Josef Reisinger, Bornheim (DE)

Correspondence Address: Dillon & Yudell LLP, 8911 N. Capital of Texas Hwy, Suite 2110, Austin, TX, 78759, US

(21) Appl. No.: 12/107,876

(22) Filed: Apr. 23, 2008

(51) Int. Cl. G06F 17/30

(52) U.S. Cl. 707/103 Y; 707/E17.023; 707/E17.055

(57) ABSTRACT

A technique for building a virtual-world (VW) object based on a real-world (RW) object description includes receiving, at a VW toolshed, a message to create a new VW object. In this case, the message uniquely identifies RW object description data that is to be accessed by an RW object management application. VW object description data that is associated with the RW object description data is then requested from the RW object management application. An instance of the new VW object is then created utilizing a VW root object included in an inventory of the VW toolshed. The inventory of the VW toolshed also includes one or more textures, one or more sounds, and one or more scripts. The instance of the new VW object then executes a script to establish a communication path between the new VW object and the VW toolshed. The VW object description data is then provided on an item-by-item basis from the VW toolshed to the new VW object. The appearance of the new VW object is then updated based on the VW object description data on the item-by-item basis.

### BACKGROUND

1. Field

This disclosure relates generally to a virtual-world object and, more specifically to techniques for providing a virtual-world object based on a real-world object description.

2. Related Art

A web browser (hereinafter “browser”) is a software application that allows a user at a client computer system (hereinafter “client”) to display and interact with text, images, and other information located on a web page at a website (hosted by an application server) on the World Wide Web or a local area network. Text and images on a web page may contain hyperlinks to other web pages at the same or different website. Browsers allow a user to quickly and easily access information provided on web pages at various websites by traversing hyperlinks. Browsers usually format hypertext markup language (HTML) information for display and, as such, an appearance of a web page may differ between browsers. A number of different browsers, e.g., Internet Explorer™, Mozilla Firefox™, Safari™, Opera™, and Netscape™, are currently available for personal computers. In general, browsers are the most commonly used type of hypertext transfer protocol (HTTP) user agent. While browsers are typically used to access web application servers (hereinafter “web servers”) that are part of the World Wide Web, browsers can also be used to access information provided by web servers in private networks or content in file systems.

For example, a browser may be utilized by a user to interact with a virtual-world (VW) provided by a VW application server. A VW is a computer-based simulated environment that various users may inhabit and interact with each other via avatars, which are usually depicted as two-dimensional (2D) or three-dimensional (3D) graphical representations. In a typical VW, perceptual stimuli is provided (via a browser) to a user, who can manipulate (via the browser) elements of the VW and, in this manner, experience a virtual presence to some degree. The VW may simulate rules based on the real-world (RW) or some fantasy world. For example, rules associated with gravity, topography, locomotion, real-time actions, and communication may be implemented. Communication between users may range from text, graphical icons, visual gesture, sound, and occasionally forms using touch and balance senses. For example, real-time voice communication using voice over Internet protocol (VoIP) may be implemented. In general, VWs may encompass a wide variety of applications, e.g., games, computer conferencing, and text based chat-rooms.

### SUMMARY

According to one embodiment of the present disclosure, a technique for building a virtual-world (VW) object based on a real-world (RW) object description includes receiving, at a VW toolshed, a message to create a new VW object. In this case, the message uniquely identifies RW object description data that is to be accessed by an RW object management application. VW object description data that is associated with the RW object description data is then requested from the RW object management application. An instance of the new VW object is then created utilizing a VW root object included in an inventory of the VW toolshed. The inventory of the VW toolshed also includes one or more textures, one or more sounds, and one or more scripts. The instance of the new VW object then executes a script to establish a communication path between the new VW object and the VW toolshed. The VW object description data is then provided on an item-by-item basis from the VW toolshed to the new VW object. The appearance of the new VW object is then updated based on the VW object description data on the item-by-item basis.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 is a block diagram of an example computer network that may be configured to provide a virtual presence including three-dimensional (3D) virtual-world (VW) objects that are based on real-world (RW) object description data according to various aspects of the present disclosure.

FIG. 2 is a flow chart of a process for providing a VW object based on an RW object description according to one embodiment of the present disclosure.

### DETAILED DESCRIPTION

As will be appreciated by one of ordinary skill in the art, the present invention may be embodied as a method, system, or computer program product. Accordingly, the present invention may take the form of an entirely hardware embodiment, an entirely software embodiment (including firmware, resident software, microcode, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer-usable or computer-readable medium may be utilized. The computer-usable or computer-readable medium may be, for example, but is not limited to, an electronic, magnetic, optical, electromagnetic, infrared, or semiconductor system, apparatus, or device. More specific examples (a non-exhaustive list) of the computer-readable medium include: a portable computer diskette, a hard disk, a random access memory (RAM), a read-only memory (ROM), an erasable programmable read-only memory (EPROM) or Flash memory, a portable compact disc read-only memory (CD-ROM), an optical storage device, or a magnetic storage device. The computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, or store the program for use by or in connection with an instruction execution system, apparatus, or device.

Computer program code for carrying out operations of the present invention may be written in an object oriented programming language, such as Java, Smalltalk, C++, etc. However, the computer program code for carrying out operations of the present invention may also be written in conventional procedural programming languages, such as the “C” programming language or similar programming languages. The program code may execute entirely on a single computer, on multiple computers that may be remote from each other, or as a stand-alone software package. When multiple computers are employed, one computer may be connected to another computer through a local area network (LAN) or a wide area network (WAN), or the connection may be, for example, through the Internet using an Internet service provider (ISP).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, implement the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the functions/acts specified in the flowchart and/or block diagram block or blocks.

The computer program instructions may also be loaded onto a computer or other programmable data processing apparatus to cause a series of operations to be performed on the computer or other programmable apparatus to produce a computer implemented process such that the instructions which execute on the computer or other programmable apparatus implement the functions/acts specified in the flowchart and/or block diagram block or blocks.

In general, a virtual world (VW), such as Second Life™, attempts to attract companies to create a virtual presence within the VW in order to generate revenue, e.g., advertising revenue. Traditionally, creating a virtual presence within a specific VW has required development of a relatively large amount of intellectual property that is tied to the specific VW. As VWs become more popular, one can assume that a number of VWs, in addition to Second Life™, will be become available. One may also assume that various companies, institutions, and/or individuals may wish to maintain a virtual presence in multiple VWs. Unfortunately, using in-world tools (i.e., tools specific to a particular VW) it may be relatively difficult and expensive to duplicate presentations in different VWs, as each VW may be implemented in different incompatible manner. In this case, an individual 3D virtual presence may be required to be created from scratch for each of a number of different VWs.

In general, as VWs allow communication to the RW and provide intelligence (i.e., using scripts) in VW objects, a virtual presence can be substantially treated like a complex software installation. In this case, a software lifecycle process and version control may be employed to maintain VW objects associated with a virtual presence. Moreover, various RW software development tools may be utilized to create VW objects and software version consistency may be ensured. Furthermore, software distribution may be utilized to effectively maintain and update a virtual presence in multiple VWs. In various embodiments, data stored on an RW server may be used to create and maintain a virtual presence in multiple VWs. The RW data, which may be transferred in a form suitable for a target VW, may be used to create VW objects and assign attributes to the VW objects.

Advantageously, the approach facilitates creating of VW objects using RW tools, which generally have greater functionality (as contrasted with in-world tools). Moreover, RW tools facilitate storage of object definitions in an RW storage. As such, an owner of a virtual presence can use well known concepts of version control and service lifecycle management in the maintenance of a virtual presence in one or more VWs. When a revised version of a virtual presence is released, RW data (associated with VW objects) can be applied to VW objects in one or more VWs in a substantially automatic manner. For example, a user can log-in to a VW and let an associated avatar observe the creation of new VW objects or the alteration of existing VW objects.

While the discussion herein is primarily directed to Second Life™, the techniques described herein are substantially applicable to other VWs (e.g., OpenSimulator™). As noted above, a number of elements in a VW may require periodic maintenance to maintain a virtual presence in the VW. For example, a virtual presence may be thought of as a piece of land that includes objects (that execute scripts) that include other objects (that may also execute scripts). In Second Life™, prims (primitive objects) are elementary building blocks that are 3D objects of a predefined shape with a set of attributes (e.g., position, size, color on each surface, and texture on each surface). Prims can usually be combined to form objects of any shape. In general, complex objects may include a relatively large number of prims, which are usually defined by their initial shape and associated attributes. Typically, manipulating VW objects with an in-world editor turns out to be a complex and error-prone operation.

As one example, known in-world editors do not include an “undo” function. As such, developing objects, especially relatively complex 3D objects, with an external tool and importing the complex 3D objects into a VW is generally desirable. Creating a library of objects outside of a VW also facilitates re-use of the objects and version control. In various embodiments, shape-specific parameters may be used to modify a basic appearance of a prim. A prim shape and necessary parameters can then typically be set (by a script) at a later time. These prim parameters may be expressed as simple data types (e.g., link, integer, floating point, and string) or complex data types (e.g., vectors and rotation). As data types are built into the Linden scripting language (LSL), creation of an object in Second Life™ usually only requires a call to an LSL function.

A prim may include many surfaces and each surface of a prim may have a different defined texture, color, and transparency. The color of a prim can usually be set by a script on a per surface basis. Colors have a built-in data type in LSL. While the texture of a surface can be set by a script, before the texture can be used, the texture needs to be uploaded to a VW grid. Sounds can also be played in a VW under control of a script. Like a texture, sounds have traditionally required manual upload to a VW. As is known, scripts are small pieces of executable code that may be created in a script language, e.g., LSL. Alternatively, a common language infrastructure (CLI) based execution environment, as provided by ECMA and used in the NET framework, may also be employed to update VW objects. Typically, the maintenance of scripts is relatively complicated as a script cannot be automatically applied to an object on a source-code level. That is, scripts are usually compiled in a VW application and downloaded to a VW grid as executables. In this case, the script source code may be part of an avatar or an object inventory.

As in-world tools do not allow for sophisticated management of a virtual presence, it is usually desirable to perform version and lifecycle management in the RW. In general, this requires the ability to create new objects and modify existing objects external to a VW. There are a number of known approaches that facilitate importing objects from the RW into a VW. For example, a known approach to creating objects for a VW relies on the creation of objects using RW tools, exporting the objects in a text or extensible mark-up language (XML) format, copying and pasting exported file content to a note card in a target VW object, and running a script which interprets the content and modifies the object accordingly. However, the known approaches require high manual interaction (selection of a VW object, etc.) and, as such, are error-prone and relatively complex, especially when a target VW object is capable of moving.

According to various aspects of the present disclosure, a representation of all 3D elements that are included in a 3D virtual presence are stored on an external server in a format that is substantially independent of a target VW. A 3D virtual presence may then be built using RW data. In this manner, when an owner of a virtual presence desires to create a similar presence in another VW, the owner can reuse the RW data (as contrasted with building a new virtual presence from scratch using in-world tools).

An RW user may employ an RW client (e.g., workstation) to create objects using a selected RW tool. An object description may be exported from the RW client in a suitable format and stored, by an object management application, in an object description repository (e.g., on a hard disk drive (HDD)). A user, e.g., using an RW client, may then trigger creation of new objects in a target VW. The trigger may be provided (by the user via a web-based interface) to the object management application or may be provided based on an in-world interaction with a VW object. In various embodiments, the object management application maintains a description of an object to be built in the target VW. A translator receives the object descriptions and converts the object description into a relatively low-level VW specific format that is transferred to a VW toolshed, which creates a VW object based on the RW object description data.

An object description repository stores objects created using a 3D tool (e.g., on a client of a user), as well as associated items like scripts, textures, and sounds. In one or more embodiments, the toolshed is a VW object that usually serves two purposes, i.e., the toolshed includes a script that communicates with an RW object management application and includes inventory with a root object, scripts, textures, and sounds that are used to provide VW objects for a virtual presence. The root object provides a template for an imported object description. In one or more embodiments, the root object includes a boot script that facilitates initial communication between a new VW object and the toolshed, after instantiation of the template as the new VW object.

RW objects may be created in any number of different manners. In any case, a created RW object includes an RW object description that is made available in an RW object description repository. In general, textures, sounds, and scripts are transferred to a VW toolshed prior to use. As noted above, a number of approaches may be used to trigger VW object creation. For example, VW object creation may be triggered by a web browser accessing an object management application or VW object creation may be triggered by an in-world interaction with a suitable dialog. In any case, when the VW toolshed receives a message to create a new VW object, the message contains an identification of the RW object description data associated with the new VW object. In response to the message, the toolshed requests data for the new VW object from the object management application.

High-level object description data in the object description repository is translated (using a translator) into a low-level format understood by the VW toolshed (which is included in a target VW). In general, RW translation facilities employ more sophisticated programming languages, as contrasted with in-world translation facilities. Moreover, RW translation generally facilitates more complex object descriptions, as well as better verification and error handling. Upon receiving the translated object description data, the toolshed uses an associated root object to create an instance of the translated object description data as a new VW object. In at least one embodiment, the new VW object runs a script that establishes a communication path with the toolshed. The toolshed transfers the received object description (item-by-item) to the new VW object, which changes an appearance from a default shape into a desired final shape.

In addition to changing the shape of a VW object, the toolshed is configured to apply textures, sounds, and scripts to a VW object. In general, a toolshed may transfer scripts from an inventory of the toolshed to any VW object. A toolshed may, for example, access a personal identification number (PIN) to start a script. In this manner, VW object maintenance can be accomplished by transferring a script to a VW object. The transferred script then accesses the object management application (using the translator) to obtain new object attributes for the VW object.

A web page may be employed to distribute scripts. For example, a PIN associated with VW objects may be set on a daily basis. Each newly created object may run a script that retrieves a PIN of the day from an object management application and modifies settings accordingly. A map may be provided with the web page that includes a picture of a virtual presence with location information for each VW object in the virtual presence. For example, a colored (e.g., red) dot may be employed to designate a scripted object on the map. In this case, an RW user may utilize an associated browser to select one the VW objects on the map and be immediately teleported to the VW object. This functionality, when implemented, enables an individual that is maintaining a virtual presence to quickly move to a VW object and perform maintenance activities on the VW object.

According to various aspects of the present disclosure, techniques for building a virtual-world (VW) object based on a real-world (RW) object description includes receiving (at a VW toolshed) a message to create a new VW object. In this case, the message uniquely identifies RW object description data that is to be accessed by an RW object management application. VW object description data (that is associated with the RW object description data) is then requested from the RW object management application. An instance of the new VW object is then created utilizing a VW root object included in an inventory of the VW toolshed. The inventory of the VW toolshed also includes one or more textures, one or more sounds, and one or more scripts. The instance of the new-virtual world object then executes a script to establish a communication path between the new VW object and the VW toolshed. The VW object description data is then provided on an item-by-item basis from the VW toolshed to the new VW object. The appearance of the new VW object is then updated based on the VW object description data (on the item-by-item basis). In this manner, an RW object description may be utilized to create VW objects in multiple VWs. Using this approach, functions that are specific to a VW may be substantially reduced to a minimum level. Minimizing VW specific functions is advantageous in that it reduces ownership issues that may be associated with a term of service (TOS) agreement of a particular VW (as in-world elements are reduced to a minimum number of general purpose functions).

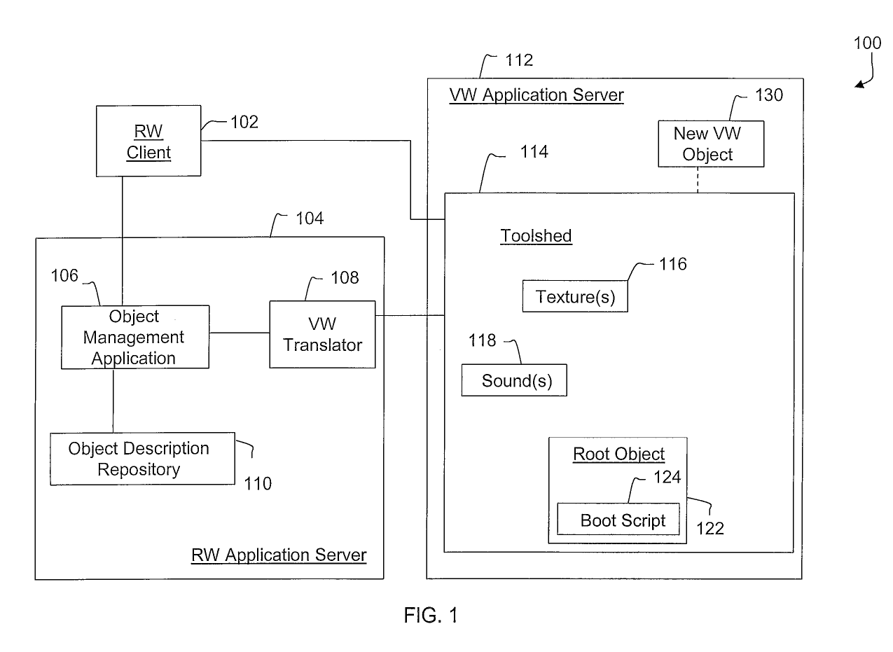

With reference to FIG. 1, a system 100 includes an RW client 102 (which may include, for example, a workstation, a laptop computer system, a notebook computer system, or a desktop computer system that is executing a browser) that is coupled (via, for example, an Internet connection and one or more Internet service providers (ISPs)) to a VW application server 112 and an RW application server 104. The RW client 102 may be configured to execute a tool that facilitates the creation of RW objects. Creation of a VW object (associated with one of the RW objects) may be initiated in-world or via the client 102. For example, an avatar or a user of the client 102 may select a VW object for modification or select to create a new VW object 130. In any case, RW object description data that is stored in an RW object description repository 110, which is coupled to an object management application 106, is retrieved by the object management application 106.

The application 106 is in communication with the RW client 102 and a VW translator 108, which translates (if necessary) the RW object description data into a format suitable for a target VW. The translator 108 may translate for a single VW or for multiple VWs. The translator 108 may, for example, create argument lists to be used in application programming interface (API) calls to a scripting language available at a target VW. As is shown in FIG. 1, a toolshed 114 includes a root object 122, which includes a boot script 124. Once the root object 122 is instantiated, a new VW object 130 may be created. The boot script 124 facilitates initial communication between the toolshed 114 and the new VW object 130. Inventory of the toolshed 114 may also include one or more textures 116, one or more sounds 118, and one or more scripts 120.

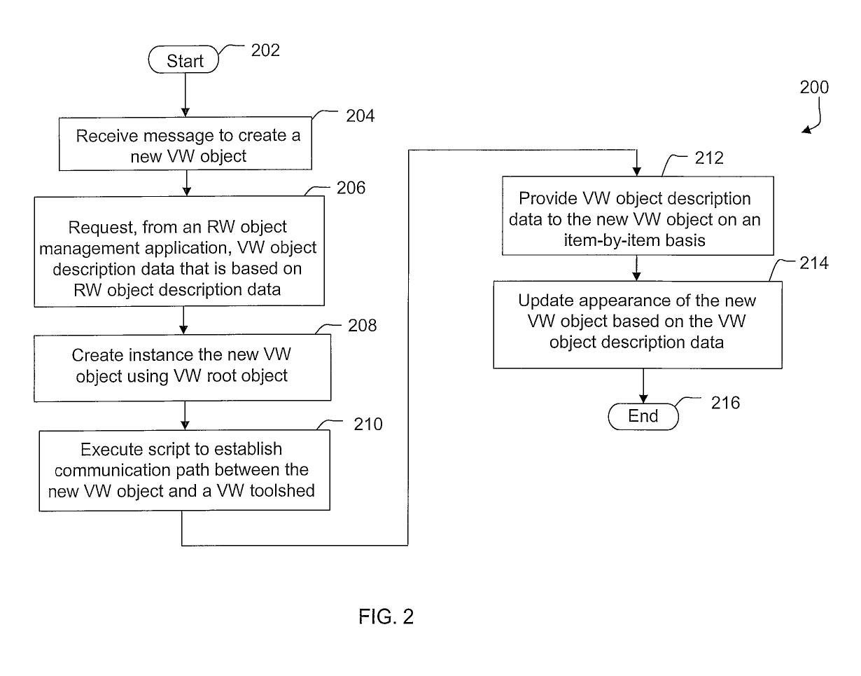

Turning to FIG. 2, a process 200 for building a VW object based on RW object description data is initiated in block 202, at which point control transfers to block 204. In block 204, a message is received at the VW toolshed 114 to create a new VW object. The new VW object may be based on modification of an existing VW object or may be constructed from scratch. In any case, the message uniquely identifies the RW object description data that is to be accessed by the RW object management application 106. Next, in block 206, VW object description data (that is associated with the RW object description data) is requested from the RW object management application. The VW object description data may be translated by the VW translator 108. Then, in block 208, an instance of the new VW object is created. In one embodiment, the VW root object 122 (included in an inventory of the VW toolshed 114) is used to create the instance of the new VW object. The inventory of the VW toolshed 114 may also include one or more textures, one or more sounds, and one or more scripts. Next, in block 210, the boot script 124 is executed to establish an initial communication path between the new VW object and the VW toolshed. Then, in block 212, the VW object description data is provided to the new VW object on an item-by-item basis. Finally, in block 214, an appearance of the new VW object is updated based on the VW object description data. Following block 214, control transfers to block 216 where the process 200 terminates.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a ”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

1. A method of building a virtual-world object based on a real-world object description, comprising:
receiving, at a virtual-world toolshed, a message to create a new virtual-world object, wherein the message uniquely identifies real-world object description data to be accessed by a real-world object management application;
requesting, from the real-world object management application, virtual-world object description data associated with the real-world object description data;
utilizing a virtual-world root object included in an inventory of the virtual-world toolshed to create an instance of the new virtual-world object, wherein the inventory of the virtual-world toolshed also includes one or more textures, one or more sounds, and one or more scripts;
executing, by the instance of the new-virtual world object, a script to establish a communication path between the new virtual-world object and the virtual-world toolshed;
providing, from the virtual-world toolshed to the new virtual-world object, the virtual-world object description data on an item by item basis; and
updating an appearance of the new virtual-world object based on the virtual-world object description data on the item by item basis.
